(19) United States
(12) Patent Application Publication
(10) Pub. No.: US 2011/0126986 A1
(43) Pub. Date: Jun. 2, 2011

(54) EASY-TO-OPERATE BAG SEALER

(76) Inventor: Po Ha Cheung, Hong Kong (HK)

(21) Appl. No.: 12/629,039

(22) Filed: Dec. 1, 2009

(51) Int. Cl. B29C 65/02

(52) U.S. Cl. 156/350

(57) ABSTRACT

The item is an easy-to-operate bag sealer that can inflate as well as vacuum, for normal household use, to keep foodstuff fresh. In the front portion of the surface of the body is the bottom frictional pressboard bar that has a frictional surface on one side. Under the cover, facing the frictional surface of the bottom frictional bar is fitted with the upper frictional pressboard bar for vacuuming or inflating. The diagonal frictional force produced by the frictional surface of the bottom frictional pressboard bar and that of the upper frictional pressboard bar is enough to enable the cover to stay closed during the process of realizing the vacuuming and inflating functions. A heat wire is located in parallel to and in the front of the bottom frictional pressboard bar and under the cover is fitted with another coordinating pressboard bar for bag sealing. Also included is an indirect switch to be pressed down to activate the vacuuming and inflating functions control, placed underneath the body, through a hole opened on the body at a corner position formed by the bottom frictional pressboard bar and the surface of the body. Under the cover, at the exact position facing the hole on the body through which the indirect switch is protruding, a cave-like opening is made on the upper frictional pressboard bar or wherever deemed appropriate. The coordinating factor of this cave-like opening and the indirect switch has a procedural function to control the activation of vacuuming and inflating.

### BACKGROUND OF THE INVENTION

1. Field of the Invention

The present invention relates to a bag sealer for household use, that can vacuum and inflate plastic bags and seal them to keep the foodstuff inside fresh. It is especially designed to inflate and vacuum the kind of plastic bags without air grooves.

2. Description of the Prior Art

The technique that the bag sealers at present adopt employs two sets of on and off control on power supply. One set is for activating the motor to either vacuum or inflate, known as vacuuming and inflating control. The other set of control is for turning on the heat wire to seal the bags by melting the plastic material and making them stick together. That is the sealing control. Through pushing buttons to switch on and off the vacuuming and inflating functions as well as sealing function, they are in general known as vacuuming and inflating on and off button, and the sealing button. They both need to be pressed down to activate their respective functions. The present on and off switches mainly have two kinds of structure, design and operation procedure.

The switch for vacuuming and inflating, and that for sealing are each located respectively on the left and the right sides underneath the body, but exposed through a hole on each side. When the side of cover is pressed onto the body, either one of the switches is touched upon and hence activates its respective function. To operate this design of machines, (Step 1) one needs to place the opening edge of plastic sleeve or sheet, tailor cut to the size required for the content, kept in position by hand between the cover and the body over the heat wire that runs along the front. Then one has to press hard on the side of the cover corresponding to the switch underneath for sealing. That turns on the heat wire to melt the plastic and hence seal the side/s to form a bag. (Step 2) Then the nozzle for airflow fixed on the body is to be placed into the opening side of the bag filled with content. After the cover is closed onto the body, one needs to press hard on the cover with both hands to prevent the air from leaking through the opening of the bag. At the same time, one hand still needs to get over to and apply force on the side of the cover corresponding to the switch underneath for vacuuming and inflating to activate the required function until desired level of vacuum or inflation is reached. (Step 3) When the desired tightness or the expansion of the bag is reached, the other hand needs once again to get over to and apply force on the side of the cover corresponding to the switch underneath to activate the heat wire to seal. Obviously, the design and structure of the on and off control switches have made the operation procedure extremely complicated. While both hands are used to press hard on the cover to prevent air leakage, one still needs to coordinate the left and right hands to apply force to the sides of the cover sequentially to activate either the motor or the heat wire. Not only does it require too much force especially for women, the sequence of pressing alternate sides is also confusing. One may easily activate the wrong function to seal the bag when he or she actually wants to activate the motor, for instance.

Recently, there comes into the market an improved version of design aiming at correcting the deficiency of first type. This version has a switch on the surface of the body for users to select what functions to activate. The switch has two positions. One is for the control of sealing. When the switch is at this position, only the heat wire can be activated. It cuts off the control of the motor; hence the machine cannot perform the vacuuming or the inflating function. The other position is to activate both the heat wire and the motor; hence all functions can be performed. In addition, this design has two hooks installed on both sides of the cover and corresponding catches on the body. When the plastic is in place, the cover can be pressed onto the body and get tightly locked onto it. One's hands are then free to carry out the operation, without having to apply pressure onto the cover during the entire process. This version also has a pressboard bar for activating the heat wire installed separately in the front of, but detached from, the cover. Users do not have to get confused about which side the control is located. However, this design also has its defects. The user must always remember to put the switch back to the position right for the step. If the user forgets to put the switch to the second position after the plastic sheet has been sealed to make the bag, he or she would find that the motor couldn't be activated after the cover is locked onto the body. The user will have to unlock the cover, lift it up, some times even to remove the bag in order to reach the switch to push it back to the right position. Besides the said inconvenience, the other deficiency is the design of the bottom and the upper pressboard bars. They are flat facing each other. The cover and the body require strong hooks to lock tightly onto each other to prevent air leakage. Therefore it requires the user to apply considerable force to press the cover hard to ensure both hooks are perfectly well secured.

The market therefore needs an invention of a new vacuuming and inflating bag sealer, that is simple, easy to operate, convenient and somewhat semi-automatic to enable everybody to use with little or no effort.

### SUMMARY OF THE INVENTION

To improve on the deficiency of the current technology and meet the market need, we hereby introduce an invention of a new vacuuming and inflating bag sealer, that is simple, easy to operate, convenient and somewhat semi-automatic to enable everybody to use with little or no effort. The techniques we adopt are as follows.

The structure an easy-to-operate bag sealer that can inflate as well as vacuum comprises a box shape body and the top cover. The bottom periphery of the top cover and the top periphery of the body match one and other in dimension. At the back part of top cover's bottom periphery and that of the body's upper periphery are linked with a set of rotating mechanism as hinges. The top cover therefore can be lifted open and closed onto the body. In the front portion of the surface of the body is the bottom frictional pressboard bar with a frictional surface on one side facing the back of the machine. Under the cover, facing the frictional surface of the bottom frictional pressboard bar is fitted with the upper frictional pressboard bar for vacuuming or inflating. The frictional surface of the bottom frictional pressboard bar is to rub with a frictional force against the lower frontal edge of the upper frictional pressboard bar for vacuuming and inflating when the top cover is closed onto the body. The diagonal frictional force produced by the frictional surface of the bottom frictional pressboard bar and that of the upper frictional pressboard bar is enough to enable the cover to stay closed during the process of realizing the vacuuming and inflating functions. A composite airflow nozzle is movably placed on the bottom frictional pressboard bar. A heat wire is installed in parallel to and in front of the bottom frictional pressboard bar on the front portion surface of the body. Under the top cover, in a position right above the heat wire when the top cover is down, another pressboard bar is installed for bag sealing. Also included is an indirect switch, connected to the on and off control placed underneath the body, to be pressed down to activate the vacuuming and inflating functions through a hole, from which it is protruded, opened on the body at a corner position formed by the said frictional side of bottom frictional pressboard bar and the surface of the body. Under the cover, at the exact position facing the hole on the body through which the indirect switch is protruding, a cave-like opening is made on the upper frictional pressboard bar or wherever deemed appropriate. The coordinating factor of this said cave-like opening and the indirect switch has a procedural function to control the activation of vacuuming and inflating.

The technicality of the structure described above is hereby further elaborated in the followings

The size of the cave-like opening made on the upper frictional pressboard bar or wherever deemed appropriate under the cover, at the exact position facing the hole on the body through which the indirect switch for activating the vacuuming and inflating functions is protruding, is larger than the protruded part of the indirect switch. Therefore, when the cover is closed onto the body, meaning that the indirect switch can then go unobstructed inside the cave-like opening made on the upper frictional pressboard bar, the part of the indirect switch protruded above the body will not touch or contact the ceiling and the inside surroundings of the said cave-like opening.

The switch to trigger the on and off control for vacuuming or inflating is called ‘indirect’ because it relies on a plastic bag to be placed flat between the protruded part itself and the said cave-like opening on the upper frictional pressboard bar to have the cave-like opening blocked. When the cover stays closed onto the body by the frictional force produced by the upper and bottom frictional pressboard bars, with the help of the presence of the bag blocking the cave-like opening, the switch can then be pushed down to trigger on the motor to perform the vacuuming and inflating functions. Without the plastic bag in between, the protrude part of the indirect switch would otherwise go inside the cave-like opening unobstructed and will not be pushed downward to trigger on the motor.

The protruded part of the said indirect switch can be a push button form of a pole, or rectangular piece in shape.

The bottom frictional pressboard bar with the frictional surface on one side can also contain a ridge running along the whole length of the bar, or a couple of curved in and out spots for the purpose of working better with the upper frictional pressboard bar under the cover to reinforce the frictional force when the two pressboard bars are biting onto each other to keep the cover stay well closed during the operation.

The trigger to activate the heat wire is located in the cover.

Two or more pieces of clips for securing in position the plastic sheet during the sealing process are installed spaced out between the heat wire and the bottom frictional pressboard bar in the front portion surface of the body, without requiring the user to hold on to the plastic sheet by hand during the sealing process.

The advantages of this invention over the current products in the market are as follows:

1) The indirect switch for triggering the motor has a procedural function. As the protruded part can go inside the cave-like opening made on the upper frictional pressboard bar unobstructed, regardless how hard one presses on the cover, the vacuuming and inflating function cannot be triggered on without having the bag first well in place with the composite airflow nozzle put inside it. However, when the plastic bag is well in place with the composite airflow nozzle already inside, the layer of plastic will be tightly, tensely stretched when the cover is closed onto the body and the upper and bottom frictional pressboard bars are then biting on each other. The layer of plastic therefore acts as a barrier to prevent the protruded part of the indirect switch from going unobstructed into the cave-like opening made under the cover on the upper frictional pressboard bar and will instead push the indirect switch protruding through the hole down to activate the motor. The advantage of this design is obvious; the motor, hence the vacuuming and inflating functions can be activated only when the bag is in place already to use. The design is simple, and users will not be confused by where to press or which switch to push during the operation.

2) Operation is easy and light. Users need not to apply large force. In the front portion of the surface of the body, there is the said bottom frictional pressboard bar that has the said frictional surface on the side facing the back of the machine. Under the cover, facing the frictional surface of the bottom frictional bar is fitted with the upper frictional pressboard bar for vacuuming or inflating. The frictional surface of the bottom frictional pressboard bar is to nib with a frictional force against the lower frontal edge of the upper frictional pressboard bar for vacuuming and inflating when the top cover is closed onto the body with the plastic bag bitten tight in between. The diagonal frictional force produced by the frictional surface of the bottom frictional pressboard bar and that of the upper frictional pressboard bar is enough to enable the cover to stay closed during the process of realizing the vacuuming and inflating functions. The bottom frictional pressboard bar, on the side with the frictional surface, can also contain a ridge running along the whole length of the bar, or a couple curved in and out spots for the purpose of working better with the upper frictional pressboard bar under the cover to reinforce the frictional force when the two pressboard bars are biting onto each other to keep the cover stay well closed during the operation. Therefore, no hooks or locks are needed, yet the operation can be carried out mostly hand free.

3) Operation becomes very easy to understand, without having to worry about finding the correct side or the correct switch. After the plastic sheet/sleeve that comes in a roll is tailor cut to the size required, the sheet can be put under the said clips to be secures in position without having to hold on to by hand. The sheet is then right over the heat wire, and the cover can be pressed down to neatly seal the openings. After a bag is made and filled with foodstuff, it can be placed, with the composite airflow nozzle inside, over the bottom frictional pressboard bar. The cover can then be closed without having to press or apply force, and the bag is tightly bitten in between with the vacuuming or inflating function activated automatically because the indirect switch is push down with the help of the bag.

4) The structure of the machine is very simple.

### BRIEF DESCRIPTION OF THE DRAWINGS

FIG. 1 is a conceptual view of the overall appearance of the new utility design (with the cover in open position);

FIG. 2 is cross section conceptual view showing the indirect switch has gone into the cave-like opening on the upper frictional pressboard bar unobstructed without touching the surrounding and ceiling of the cave-like opening when the cover is closed onto the body but with no the bag bitten in between.

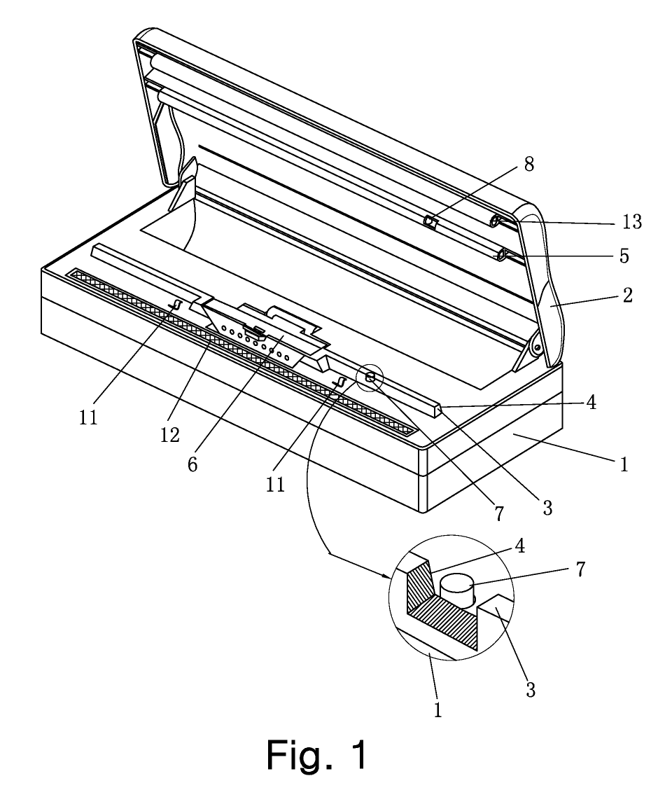

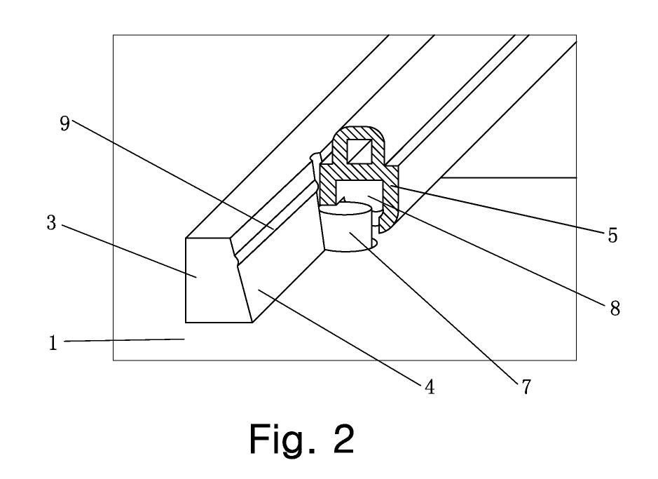

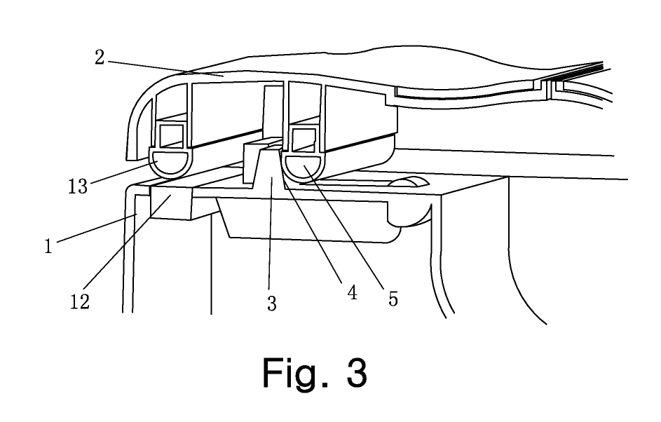

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Using the attached diagrams as reference, the detailed description of how the new utility design can realize its functions is made in the followings.

As the diagram shows, the structure of an easy-to-operate bag sealer that can inflate as well as vacuum comprises a box shape body (1) and the top cover (2). The bottom periphery of the top cover (2) and the top periphery of the body (1) match one and other in dimension. At the back part of top cover (2)'s bottom periphery and that of the body (1)'s upper periphery are linked with a set of rotating mechanism as hinges. The top cover (2) therefore can be lifted open and closed onto the main body (1). In the front portion of the surface of the body 1 is the bottom frictional pressboard bar (3) with a frictional surface (4) on one side facing the back of the machine. Under the cover (2), facing the frictional surface (4) of the bottom frictional pressboard bar (3) is fitted with the upper frictional pressboard bar (5) for vacuuming or inflating. The frictional surface (4) of the bottom frictional pressboard bar (3) is to nib with a frictional force against the lower frontal edge of the upper friction pressboard bar (5) for vacuuming and inflating when the top cover (2) is closed onto the body (1). A composite airflow nozzle (6) is movably placed on the bottom frictional pressboard bar (3). A heat wire (12) is installed in parallel to and in front of the bottom frictional pressboard bar (3) on the front portion surface of the body (1). Under the top cover (2), in a position right above the heat wire (12) when the top cover (1) is down, another pressboard bar (13) is installed for bag sealing. Also included is an indirect switch (7), connected to the on and off control placed underneath the body (1), to be pressed down to activate the vacuuming and inflating functions through a hole, from which it is protruded, opened on the body (1) at a corner position formed by the said frictional surface (4) of bottom frictional pressboard bar (3) and the surface of the body (1). Under the cover (2), at the exact position facing the hole on the body (1) through which the indirect switch (7) is protruding, a cave-like opening (8) is made on the upper frictional pressboard bar (5) or wherever deemed appropriate. The coordinating factor of this said cave-like opening (8) and the indirect switch (7) has a procedural function to control the activation of vacuuming and inflating.

The size of the said cave-like opening (8) made on the upper frictional pressboard bar (5) or wherever deemed exactly facing the hole on the body through which the indirect switch (7) for activating the vacuuming and inflating functions is protruding, is larger than the protruded part of the indirect switch (7). Therefore, when the cover (2) is closed onto the body (1), meaning that the indirect switch (7) can then go unobstructed inside the cave-like opening (8) made on the upper frictional pressboard bar (5) or wherever deemed appropriate, the part of the indirect switch (7) protruded above the body will not touch or contact the ceiling and the inside surroundings of the said cave-like opening (8).

The protruded part of the said indirect switch (7) can be a pole form of push button, or rectangular piece in shape.

The diagonal frictional force produced by the frictional surface (4) of the bottom frictional pressboard bar (3) and that of the upper frictional pressboard bar (5) is enough to enable the cover (2) to stay closed during the process of realizing the vacuuming and inflating functions.

The bottom frictional pressboard bar (3) with the frictional surface (4) on one side can also contain a ridge (9) running along the whole length of the bar, or a couple curved in and out spots for the purpose of working better with the upper frictional pressboard bar (5) under the cover (2) to reinforce the frictional force when the two pressboard bars (3&5) are biting onto each other to keep the cover (2) stay well closed during the operation.

The trigger to activate the heat wire is located in the cover (2).

Two or more pieces of clips (11) for securing in position the plastic sheet or bag during the sealing process are installed left and right spaced out symmetrically between the heat wire (12) and the bottom frictional pressboard bar (3) in the front portion surface of the body (1).

The vacuuming and inflating control mechanism installed underneath the body (1) can be a tiny switch control put in a position connected to the said indirect switch (7) for activating the functions.

The pressboard bars can be made of rubber or plastic or plastic coated with rubber.

All the descriptions made so far are only better illustration of instances of how to realize the uniqueness of this invention; they are however by no means setting limitation or restriction on the parameter of our engineering and technology. Any further detailed adjustments, alternations and changes of appearance made by those who understand the technology, based on the actual technology of this new design illustrated above, all are within its technical boundary.

What is claimed is:

1. An easy-to-operate bag sealer being both vacuum and inflate and comprising a box shape body (1) and the top cover (2). The bottom periphery of the top cover (2) and the top periphery of the body (1) match one and other in dimension, at the back part of top cover (2)'s bottom periphery and that of the body (1)'s upper periphery are linked with a set of rotating mechanism as hinges, the top cover (2) therefore can be lifted open and closed onto the main body (1). At the front portion of the body (1) and in parallel to the front edge of the body (1) is the bottom frictional pressboard bar (3). This bottom frictional pressboard bar (3) has a frictional surface (4) facing towards the back of the body (1). An upper frictional pressboard bar (5) for vacuuming and inflating fitted to face the frictional surface (4) of the bottom frictional pressboard bar (3) is located under the top cover (1). The frictional surface (4) of the bottom frictional pressboard bar (3) is to rub with a frictional force against the lower frontal edge of the upper frictional pressboard bar (5) for vacuuming and inflating when the top cover (2) is closed onto the body (1). A composite airflow nozzle (6) is movably placed on the bottom frictional pressboard bar (3). A heat wire (12) is installed in parallel to and in front of the bottom frictional pressboard bar (3) on the front portion surface of the body (1). Under the top cover (2), in a position right above the heat wire (12) when the top cover (2) is down, another pressboard bar (13) is installed for bag sealing. Its uniqueness therein also includes the indirect switch (7) protruding from underneath the body (1) to be pressed down to activate the vacuuming and inflating functions through a hole opened on the body (1) at a corner position formed by the frictional surface (4) side of the bottom frictional pressboard bar (3) and the surface of the body (1). This indirect switch (7) is connected to the on and off control of vacuuming and inflating functions installed underneath the surface of the body (1). Under the cover (2), at the exact position facing the hole on the body (1) through which the indirect switch (7) is protruding, a cave-like opening (8) is made on the upper frictional pressboard bar (5) or wherever deemed appropriate.

2. The easy-to-operate bag sealer as claimed in claim 1: wherein the size of the said cave-like opening (8), made on the upper frictional pressboard bar (5) at the exact position facing the hole on the body (1) through which the indirect switch (7) for activating the vacuuming and inflating functions is protruding, is larger than the protruded part of the indirect switch (7), therefore, when the cover (2) is closed onto the body (1), meaning that the indirect switch (7) is then inside the cave-like opening (8) made on the upper frictional pressboard bar (5), the part of the indirect switch protruded above the body (1) cannot touch or contact the ceiling and the inside surroundings of the said cave-like opening (8).

3. The easy-to-operate bag sealer as claimed in claim 1: wherein the part of indirect switch (7) protruded above the body (1) through a hole can be in a shape of a round pole or a piece of other shapes.

4. The easy-to-operate bag sealer as claimed in claim 1: wherein a trigger to control the on and off of the bag sealing process can be installed on the cover (2).

5. The easy-to-operate bag sealer as claimed in claim 1: wherein pieces of clips (11) for securing in position the plastic sheet or bag during the sealing process are installed spaced out between the heat wire (12) and the bottom frictional pressboard bar (3) in the front portion surface of the body (1).
